(19) United States
(12) Patent Application Publication
(10) Pub. No.: US 2010/0044596 A1
(43) Pub. Date: Feb. 25, 2010

(54) IMAGE EXPOSING METHOD AND APPARATUS

(75) Inventor: Hiromi Ishikawa, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, TOKYO (JP)

(21) Appl. No.: 11/721,018

(22) PCT Filed: Dec. 1, 2005
(86) PCT No.: PCT/JP05/22512

§ 371 Date: Jun. 6, 2007

(51) Int. Cl. G21K 5/10

(52) U.S. Cl. 250/492.22

(57) ABSTRACT

An image exposing apparatus capable of avoiding degradation in the resolution of an exposed image due to fluctuations in the traveling direction of light that focuses pixel images of the pixel sections of a spatial optical modulation device. The apparatus includes the spatial optical modulation device, such as a DMD having multitudes of pixel sections disposed two-dimensionally; a light source; and image focusing optical systems. It further includes an aperture array disposed at the image location focused by the image focusing optical systems such that each of the pixel images of the pixel sections is positioned at the plane of each of the apertures. The pixel images positioned at the aperture planes of the aperture array are focused into an image by a microlens array, which is then projected onto a photosensitive material by optical systems.

### TECHNICAL FIELD

The present invention relates to an image exposing apparatus. More specifically, the present invention is directed to an image exposing apparatus, in which a photosensitive material is exposed by focusing thereon an optical image represented by light modulated by a spatial optical modulation device.

The present invention also relates to an image exposing method that uses such an image exposing apparatus.

### BACKGROUND ART

Image exposing systems, in which light modulated by a spatial optical modulation device is passed through an image focusing optical system to focus an image represented by the light on a predetermined photosensitive material in order to expose it with the image are known. Basically, such an image exposing system includes a spatial optical modulation device having multitudes of pixel sections arranged two-dimensionally, each for modulating irradiated light in accordance with a control signal; a light source for irradiating light on the spatial optical modulation device; and an image focusing optical system for focusing an optical image represented by light modulated by the spatial optical modulation device on a photosensitive material.

In such an image exposing system, a device such as an LCD (liquid crystal display), DMD (digital micromirror device), or the like may preferably be used as the spatial optical modulation device. The DMD described above is a mirror device in which multitudes of rectangular micromirrors that change the angle of the reflecting surface according to a control signal are disposed two-dimensionally on a semiconductor substrate made of, for example, silicon or the like.

In the image exposing system described above, it is often the case that an image needs to be enlarged before being projected on the photosensitive material. If that is the case, an image magnifying and focusing optical system is used as the image focusing optical system. Simple passage of light propagated via the spatial optical modulation device through the image magnifying and focusing optical system may results in a broader light beam from each of the pixel sections of the spatial optical modulation device. Thus, the pixel size in the projected image becomes larger and the sharpness of the image is degraded.

Consequently, a consideration has been given to enlarge and project an image using first and second image focusing optical systems. In this configuration, the first image focusing optical system is disposed in the optical path of light modulated by the spatial optical modulation device with a microlens array constituted by microlenses, each corresponding to each pixel section of the spatial optical modulation device, arranged in an array being disposed at the image focusing plane of the first image focusing optical system, and the second image focusing optical system for focusing the image represented by the modulated light on a photosensitive material or screen is disposed in the optical path of the light passed through the microlens array. In the configuration described above, the size of the image projected on a photosensitive material or screen may be enlarged, and yet the sharpness of the image may be maintained at high level, since the light from each pixel section of the spatial optical modulation device is focused by each microlens of the microlens array, thereby the pixel size (spot size) in the projected image is narrowed down and maintained at a small size.

One of such image exposing systems that uses a DMD as the spatial optical modulation device in combination with a microlens array is described in Japanese Unexamined patent Publication No. 2001-305663. A similar type of image exposing system is described in Japanese Unexamined patent Publication No. 2004-122470. In the system, an aperture array (aperture plate) having apertures, each corresponding to each microlens of the microlens array, is disposed behind the microlens array to allow only the light propagated via a corresponding microlens to pass through the aperture. This configuration prevents light from the adjacent microlenses that do not correspond to the aperture of the aperture plate from entering the aperture, so that stray light may be prevented from entering the adjacent pixels. Further, a small amount of light may sometimes be incident on the exposing surface even when the pixels (micromirrors) of the DMD are turned off to shut out the light. In this case also, the configuration described above may reduce the amount of light present on the exposing surface when the pixels of the DM are turned off.

The conventional image exposing system that combines a spatial optical modulation device with a microlens array has a problem that the light beam focused by each microlens of the microlens array fluctuates to a small extent on the photosensitive material. This results in as if the exposure was performed by a light beam having a larger spot diameter and the resolution of the exposed image is degraded.

In particular, this problem is more significant when a DMD is used as the spatial optical modulation device. Hereinafter, the problem when a DMD is used as the spatial optical device will be described in detail. FIG. 17 illustrates the response characteristic of a micromirror of a DMD. Here, it is assumed that the micromirror takes the position which is −12 degrees away from the reference position (substrate surface) when it is turned off, and the position which is +12 degrees away from the reference position when it is turned on. In FIG. 17, assuming that an “on” signal is inputted at time 0, the micromirror should ideally take the position of +12 degrees immediately and become stationary thereat. In reality, however, chattering occurs within a certain angle range centered on +12 degrees due to the inertia and bounce of the fluctuating micromirror. Thus, the micromirror becomes stationary only after the chattering is converged.

In the conventional system, the microlens array is disposed such that the microlenses are located on the image focusing plane of the first image focusing optical system as described earlier, if the response of the micromirror has the transient response characteristic described above, the beam angle of the light entering the microlens fluctuates to a small extent. This leads to positional fluctuations of the light beam on the photosensitive material.

So far the problem when a DMD is used as the spatial optical modulation device has been described. Even in the case where a different type of spatial optical modulation device is employed, if the beam angle of the light entering the microlens fluctuates for one reason or another, the same problem of degradation in the resolution of the exposed image occurs.

In view of the circumstances described above, it is an object of the present invention to provide an image exposing apparatus that combines a spatial optical modulation device with a microlens array and an image exposing method which are capable of assuring a high resolution for the exposed image.

### DISCLOSURE OF INVENTION

Whereas in the conventional image exposing apparatus, the pixel images of the pixel sections of the spatial optical modulation device are focused at the location of the microlens array, they are focused at respective aperture planes of an aperture array, which are then focused into an image on the photosensitive material by the microlens array, or the microlens array and an additional projecting optical system in the image exposing apparatuses according to the present invention.

More specifically, the first image exposing apparatus according to the present invention is an image exposing apparatus in which a photosensitive material is exposed by light propagated via a spatial optical modulation device to represent an image, the apparatus comprising:

the spatial optical modulation device including a plurality of pixel sections disposed in an array, each for modulating light irradiated thereon;

a light source for irradiating light on the spatial optical modulation device;

an image focusing optical system for condensing the light propagated via the spatial optical modulation device and focusing each of the pixel images of the pixel sections;

an aperture array made of an opaque material with a plurality of apertures disposed in an array, which is placed at the image location focused by the image focusing optical system such that each of the pixel images of the pixel sections is positioned at each of the aperture planes;

a microlens array including a plurality of microlenses disposed in an array, each for focusing each of the pixel images positioned at each of the aperture planes at a predetermined location; and

an optical system for focusing and projecting the image focused by the microlens array on the photosensitive material.

Here, the plurality of pixel sections, apertures, and microlenses described above may be disposed in two-dimensional arrays or one-dimensional array.

Such kind of aperture array described above is also disclosed, for example, in Japanese Unexamined Patent Publication No. 2004-122470. But the aperture array disclosed therein is disposed in front of or behind the microlens array to shut out the light propagating in the surrounding and outer regions of the microlenses of the micromirror array. It is definitely the microlens array, not the aperture array as in the present invention, which is disposed at the image location of the pixel sections of the spatial optical modulation device. Thus, the image exposing apparatus disclosed therein is different from that of the present invention in this respect.

The second image exposing apparatus according to the present invention is an image exposing apparatus that comprises a spatial modulation device, a light source, an image focusing optical system, and an aperture array, which are identical to those in the first image exposing apparatus described above. It further comprises a microlens array including a plurality of microlenses disposed in an array, each for focusing each of the pixel images positioned at each of the aperture planes on the photosensitive material.

Preferably, in each of the apparatuses according to the present invention, a DMD in which micromirrors serving as the pixel sections are disposed two-dimensionally is used as the spatial modulation device.

The image exposing method according to the present invention is a method for exposing a predetermined pattern on a photosensitive material using any of the image exposing apparatuses of the present invention described above.

In the image exposing apparatuses according to the present invention, the pixel images of the pixel sections of the spatial optical modulation device are focused at the respective aperture planes of the aperture array, which are then focused by the microlens array. This arrangement allows the image location focused by the microlens array to be maintained unchanged for the light from the pixel sections of the spatial optical modulation device entering the respective aperture planes at any incident angle. In the first image exposing apparatus in which the image focused by the microlens array is projected on the photosensitive material using a further optical system or in the second image exposing apparatus in which the image focused by the microlens array is directly focused on the photosensitive material, degradation in the resolution of the exposed image due to fluctuations in the beam positions on the photosensitive material arising from changes in the incident angle described above may be prevented.

Further, pixel images positioned at respective aperture planes of the aperture array are focused by the microlens array as described above, so that the beam diameter on the photosensitive material remains unchanged even when the beam diameter of the beam entering the aperture array 59 is fluctuated due to field curvature, astigmatic difference, and the like of the image focusing optical system disposed in front of the aperture array. This also allows a high resolution image to be exposed.

Preferably, the image exposing apparatuses according to the present invention are constructed to employ a DMD that includes microlenses disposed two-dimensionally as the spatial optical modulation device, since aforementioned problems which are more likely to occur in the DMD due to the transient response characteristic of the micromirrors may be prevented.

The image exposing method according to the present invention is a method for exposing a predetermined pattern on a photosensitive material using any of the image exposing apparatuses of the present invention. Therefore, the method may prevent the aforementioned problems reliably.

### BRIEF DESCRIPTION OF DRAWINGS

FIG. 1 is a perspective view of an image exposing apparatus according to a first embodiment of the present invention, illustrating the overview thereof.

FIG. 2 is a perspective view of a scanner of the image exposing apparatus shown in FIG. 1 illustrating the construction thereof.

FIG. 3A is a plan view of a photosensitive material, illustrating exposed regions thereof.

FIG. 3B is a drawing illustrating the disposition of the exposing area of each exposing head.

FIG. 4 is a perspective view of an exposing head of the image exposing apparatus shown in FIG. 1, illustrating the schematic construction thereof.

FIG. 5 is a schematic cross-section view of the exposing head described above.

FIG. 6 is a partially enlarged view of a digital micromirror device (DMD), illustrating the construction thereof.

FIG. 7A is a drawing for explaining the operation of the DMD.

FIG. 7B is a drawing for explaining the operation of the DMD.

FIG. 8A is a plan view of a DMD, illustrating the arrangement of the exposing beams and scanning lines when the DMD is not inclined relative to the subscanning direction.

FIG. 8B is a plan view of a DMD, illustrating the arrangement of the exposing beams and scanning lines when the DMD is inclined relative to the subscanning direction.

FIG. 9A is a perspective view of a fiber array light source, illustrating the construction thereof.

FIG. 9B is a front elevational view, illustrating the disposition of luminous points at the laser output section of the fiber array light source.

FIG. 10 is a drawing illustrating the construction of a multimode optical fiber.

FIG. 11 is a plan view of a beam-combining laser light source, illustrating the construction thereof.

FIG. 12 is a plan view of a laser module, illustrating the construction thereof.

FIG. 13 is a side view of the laser module shown in FIG. 12, illustrating the construction thereof.

FIG. 14 is a partial front view of the laser module shown in FIG. 12, illustrating the construction thereof.

FIG. 15 is a block diagram illustrating the electrical configuration of the image exposing apparatus described above.

FIG. 16A is a drawing illustrating an example area of use in a DMD.

FIG. 16B is a drawing illustrating an example area of use in a DMD.

FIG. 17 is a drawing illustrating the transient response characteristic of a micromirror comprising the DMD.

FIG. 18 is a schematic cross-sectional view of an exposing head used in an image exposing apparatus according to a second embodiment of the present invention.

### BEST MODE FOR CARRYING OUT THE INVENTION

Hereinafter, preferred embodiments of the present invention will be described in detail with reference to the accompanying drawings. The image exposing apparatus according to a first embodiment will be described first.

### [Construction of the Image Exposing Apparatus]

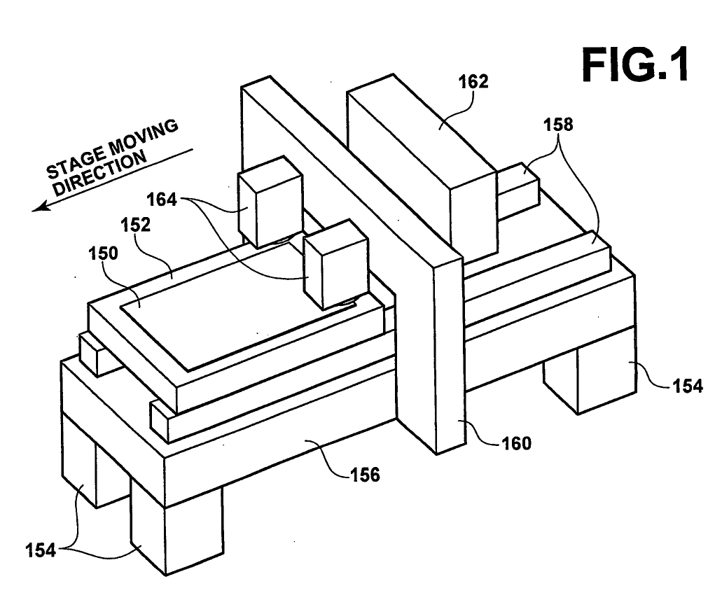

As shown in FIG. 1, the image exposing apparatus of the present embodiment includes a plate-like moving stage 150 for holding a sheet-like photosensitive material 12 thereon by suction. Two guides 158 extending along the moving direction of the stage are provided on the upper surface of a thick plate-like mounting platform 156 which is supported by four legs 154. The stage 152 is arranged such that its longitudinal direction is oriented to the moving direction of the stage, and movably supported by the guides 158 to allow back-and-forth movements. The image exposing apparatus of the present embodiment further includes a stage driving unit 304 (FIG. 15), which will be described later, for driving the stage 152 that serves as a sub-scanning means along the guides 158.

An inverse U-shaped gate 160 striding over the moving path of the stage 152 is provided at the central part of the mounting platform 156. Each of the ends of the inverse U-shaped gate 160 is fixedly attached to each of the sides of the mounting platform 156. A scanner 162 is provided on one side of the gate 160, and a plurality of sensors 164 (e.g. two) for detecting the front and rear edges of the photosensitive material 150 is provided on the other side. The scanner 162 and sensors 164 are fixedly attached to the gate 160 over the moving path of the stage 152. The scanner 162 and sensors 164 are connected to a controller (not shown) that controls them.

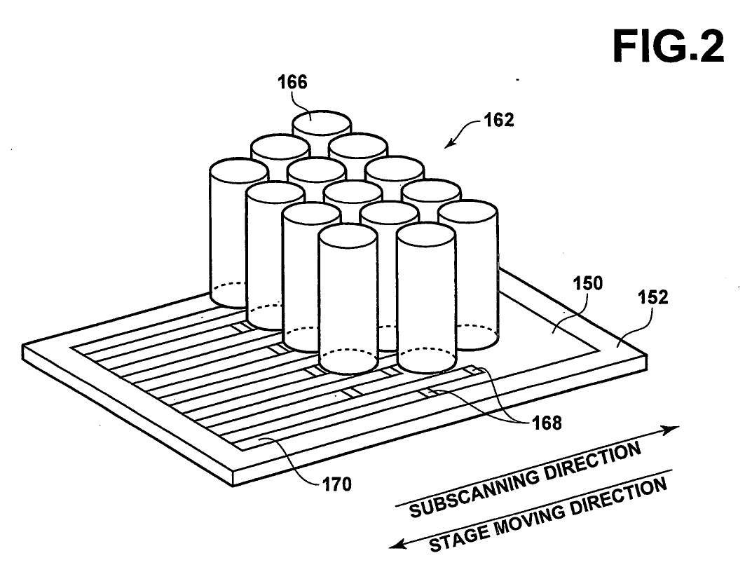

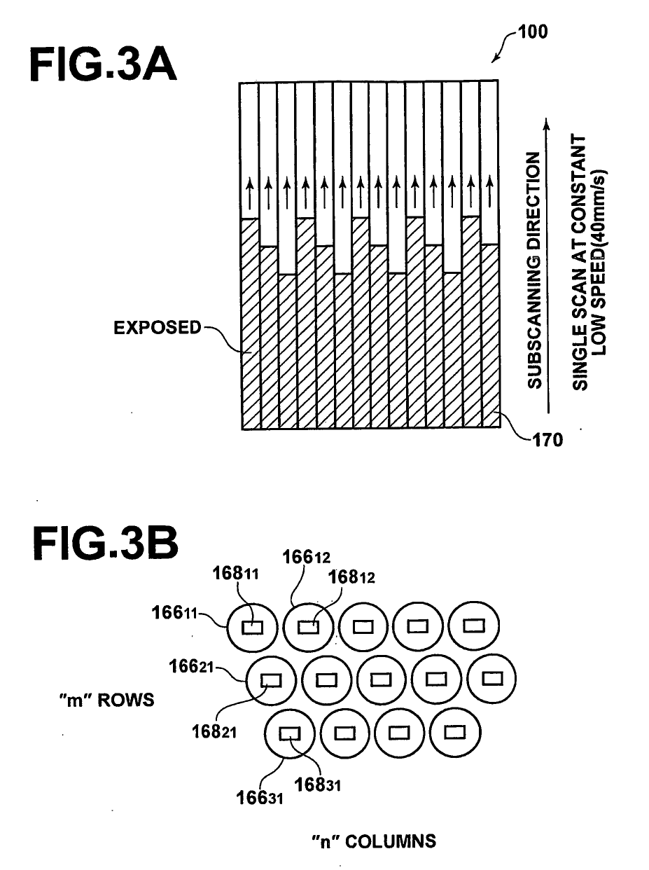

As shown in FIGS. 2 and 3B, the scanner 162 includes a plurality of exposing heads 166 (e.g. fourteen) disposed in matrix form in “m” rows and “n” columns. In this example, four exposing heads 166 are disposed in the third row in relation to the width of the photosensitive material 150. Hereinafter, the exposing head disposed at the n^{th} column of the m^{th} row will be designated as the exposing head 166ₘₙ.

The exposing area 168 of each exposing head 166 has a rectangular form with the short side oriented in the sub-scanning direction. Accordingly, a stripe-shaped exposed region 170 is formed on the photosensitive material 150 by each of the exposing heads 166 as the stage 152 moves. Hereinafter, the exposing area of the exposing head disposed at the n^{th} column of the m^{th} row will be designated as the exposing area 168ₘₙ.

As shown in FIGS. 3A and 3B, each of the exposing heads 166 arranged linearly in a row is displaced by a predetermined distance (e.g., a natural number multiple of the long side of the exposing area, twice the long side in this case) in the arranging direction such that each of the stripe-shaped exposed regions 170 is disposed without any gap with the adjacent exposed regions 17d in the orthogonal direction to the sub-scanning direction. Consequently, the unexposed region of the photosensitive material which corresponds to the space between the exposing areas 168₁₁ and 168₁₂ in the first row may be exposed by the exposing area 168₂₁ in the second row and the exposing area 168₃₁ in the third row.

Each of the exposing heads 166₁₁ to 166mn has a digital micromirror device (DMD) 50, which is available from U.S. Texas Instruments Inc., as the spatial optical modulation device that modulates the incident light beam on a pixel by pixel basis according to image data. The DMD 50 is connected to a controller 302 (FIG. 15) to be described later. The controller 302 includes a data processing section and a mirror drive controlling section. The data processing section of the controller 302 generates a control signal for drive controlling each of the micromirrors within an area of the DMD 50 to be controlled for each of the exposing heads 166 based on inputted image data. The meaning of the “area to be controlled” will be provided hereinafter. The mirror drive controlling section controls the angle of the reflecting surface of each of the micromirrors of the DMD 50 for each of the exposing heads 166 based on the control signal generated by the image data processing section. A method for controlling the angle of the reflecting surface of each of the micromirrors will be described later.

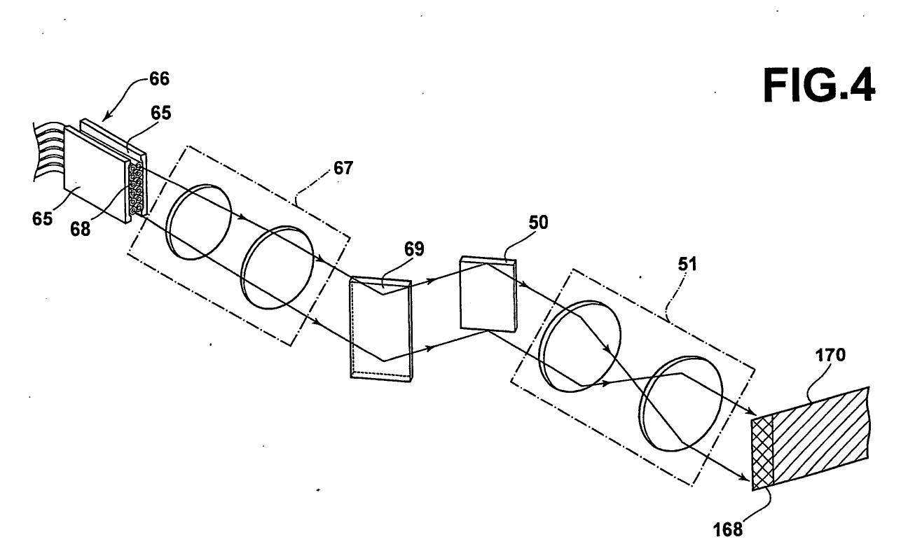

A fiber array light source 66 having a laser output section in which output faces (luminous points) of optical fibers are arranged linearly along the direction corresponding to the direction of the long side of the exposing area 168; a lens system 67 for correcting and focusing the laser beam outputted from the fiber array light source 66 on the DMD; and a mirror 69 for reflecting the laser beam transmitted through the lens system 67 toward the DMD 50 are disposed in this order on the light entry side of the DMD 50. In FIG. 4, the lens system 67 is illustrated schematically.

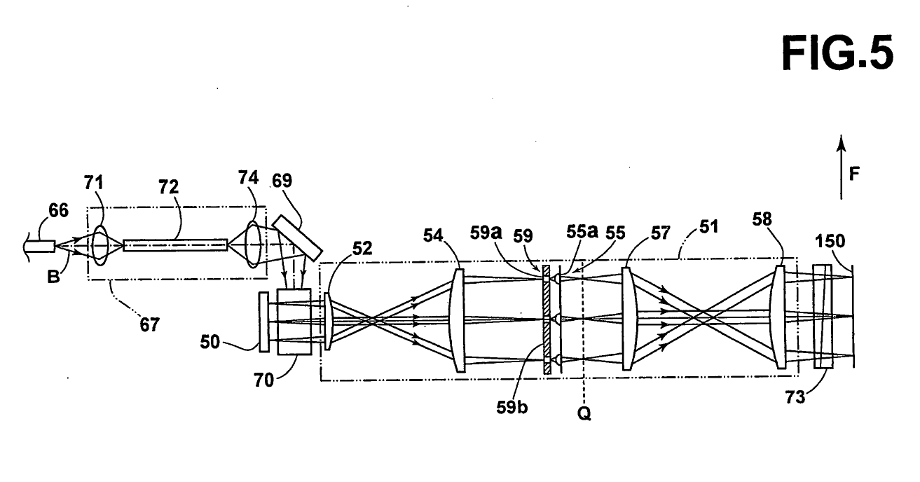

As is illustrated in detail in FIG. 5, the lens system 67 includes a condenser lens 71 for condensing a laser beam B as the illuminating light emitted from the fiber array light source 66, a rod-shaped optical integrator 72 (hereinafter referred to as “rod integrator) placed in the light path of the light transmitted through the condenser lens 71, and an image focusing lens 74 disposed ahead of the rod integrator 72, that is, on the side of the mirror 69. The laser beam emitted from the fiber array light source 66 is irradiated on the DMD 50 through the condenser lens 71, rod integrator 72, and image focusing lens 74 as a substantially collimated light beam having homogeneous luminous intensity in the cross section. The shape and function of the rod integrator 72 will be described in detail later.

The laser beam B outputted from the lens system 67 is reflected by the mirror 69, and irradiated on the DMD 50 through a TIR (total internal reflection) prism 70. In FIG. 4, the TIR prism 70 is omitted.

An image focusing optical system 51 for focusing the laser beam B reflected by the DMD 50 on the photosensitive material 150 is disposed on the light reflecting side of the DMD 50. The image focusing optical system 51 is schematically shown in FIG. 4. As is illustrated in detail in FIG. 5, the image focusing optical system 51 includes a first image focusing optical system constituted by lens systems 52, 54, a second image focusing optical system constituted by lens systems 57, 58. It further includes a microlens array 55, and an aperture array 59, which are placed between the two image focusing optical systems.

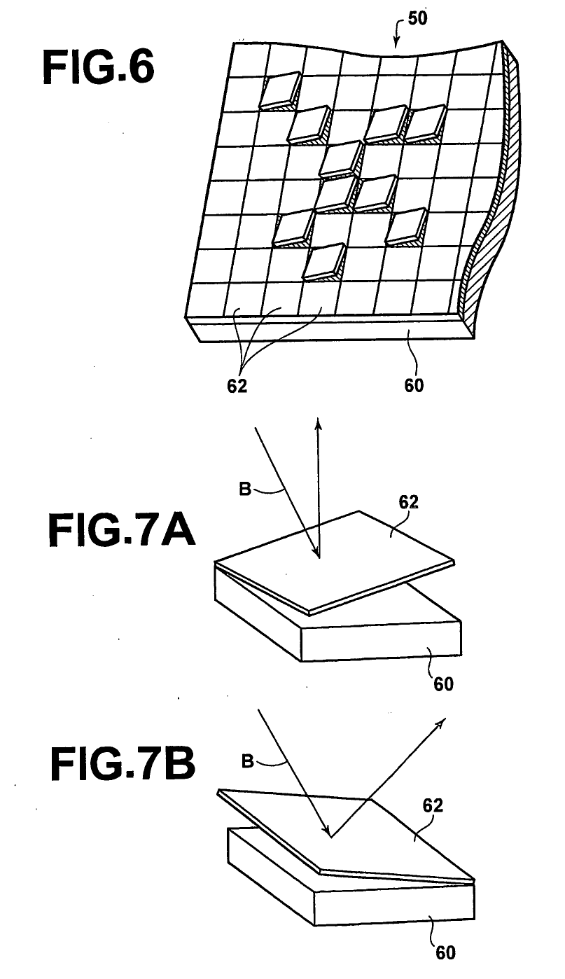

As shown in FIG. 6, the DMD 50 is a mirror-device constituted by multitudes of micromirrors 62 (e.g., 1024×768), each forming a pixel, are disposed in a lattice pattern on SRAM cells (memory cells) 60. In each pixel, a rectangular micromirror is provided at the top, which is supported by a support post. A highly reflective material, such as aluminum or the like, is deposited on the surface of the micromirror. The reflectance of the micromirror is not less than 90%. The size of the micromirror is, for example, 13 μm in both longitudinal and lateral directions, and the arranging pitch is, for example, 13.7 μm in both directions. A silicon-gate CMOS SRAM cell 60, which may be produced on a common manufacturing line for manufacturing semiconductor memories, is provided beneath each of the micromirrors 62 through the support post having a hinge and a yoke. The entire DMD is constructed monolithically.

When a digital signal is written into the SRAM cell 60 of the DMD 50, the micromirror supported by the support post is tilted within the range of ±α degrees (e.g., ±12 degrees) centered on the diagonal line relative to the substrate on which the DMD 50 is disposed. FIG. 7A shows the micromirror 62 tilted by +α degrees, which means that it is in on-state, and FIG. 7B shows the micromirror 62 tilted by −α degrees, which means that it is in off-state. Accordingly, by controlling the tilt of the micromirror 62 in each pixel of the DMD 50 according to image signals as shown in FIG. 6, the laser beam B incident on the DMD 50 is reflected to the tilt direction of each of the micromirrors 62.

FIG. 6 is a partially enlarged view of the DMD 50, illustrating an example state in which some of the micromirrors in a portion of the DMD 50 are controlled to tilt by + or −α degrees. The on-off control of each of the micromirrors 62 is implemented by the controller 302 connected to the DMD 50. A light absorption material (not shown) is disposed in the propagating direction of the laser beam B reflected by the micromirrors which are in “off” state.

The aperture array 59 is made of an opaque member 59b with a plurality of round apertures (openings) 59a disposed two-dimensionally. The aperture array 59 is placed at the image location of the micromirrors 62 of the DMD 50 focused by the first image focusing optical system such that each of the images of the micromirrors 62 is positioned at the plane of each of the apertures 59a. In the present embodiment, the diameter of the aperture 59a is 9 μm.

In the mean time, the microlens array 55 is constituted by multitudes of microlenses 55a disposed two-dimensionally, each corresponding to each of the apertures of the aperture array 59 (i.e., each of the micromirrors of the DMD 50). The image positioned at the plane of each of the apertures 59a is focused by each of the corresponding microlenses 55a on the image focusing plane Q. Although the DMD has 1024 pieces×768 columns of micromirrors in total, only 1024 pieces×256 columns are driven in the present embodiment as will be described later. Thus, corresponding number of 1024 pieces×256 columns of the microlenses 55a are disposed.

The image of the micromirror 62 of the DMD 50 is magnified by 1.5 times, i.e., to the size of approximately 20 μm×20 μm, and focused on the aperture array 59 by the first image focusing optical system. Consequently, only a less distorted image of the micromirror 62 at the central region is observed through the aperture 59a having a smaller diameter of 9 μm as described above. As an example, the microlens array 55 is made of optical glass BK7, and each of the microlenses has the focal length of 75 μm, and focuses the image at the plane of each of the corresponding apertures 59a by magnifying it by ⅓. Then, the image is focused at the same magnification on the photosensitive material 150 by the second image focusing optical system constituted by the lens systems 57, 58. That is, the image at the plane of the aperture 59a is focused and projected on the photosensitive material as an image of 3 μm in diameter here.

In the present embodiment, a prism pair 73 is disposed between the second image focusing optical system and photosensitive material 150, and the focus of the image on the photosensitive material 150 may be adjusted by moving the prism pair 73 in up and down directions in FIG. 5. In FIG. 5, the photosensitive material 150 is fed in the subscanning direction indicated by the arrow F.

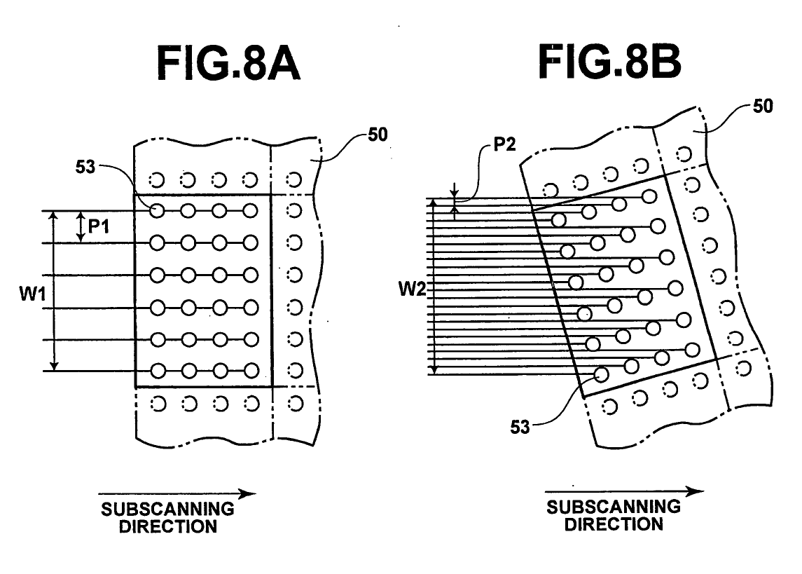

Preferably, the DMD 50 is disposed in slightly inclined manner so that the short side thereof forms a predetermined angle θ (e.g., 0.1 to 5 degrees) with the subscanning direction. FIG. 8A illustrates the scan trace of the reflected light image 53 (exposing beam) produced by each of the micromirrors when the DMD 50 is not inclined, and FIG. 8B illustrates the scan trace of the exposing beam 53 from each of the micromirrors when the DMD 50 is inclined.

The DMD 50 includes multitudes of micromirror columns (e.g., 756) disposed in the transverse direction, each having a multitude of micromirrors (e.g., 1024) disposed in the longitudinal direction. As shown in FIG. 8B, the pitch P₂ between the scan traces (scanning lines) of the exposing beams 53 produced by the micromirrors becomes narrower by inclining the DMD 50 than the pitch P₁ when it is not inclined, and image resolution is improved significantly. In the mean time, the inclination angle of the DMD 50 relative to the subscanning direction is very small so that a scanning width W₂ when the DMD is inclined is approximately the same as a scanning width W₁ when it is not inclined.

Further, the same scanning line is exposed a plurality of times by the different micromirror columns (multiple exposures). The multiple exposures allow fine control of exposing position and a high resolution exposure may be realized. Further, the seam between a plurality of exposing heads disposed in the main scanning direction may be smoothed out by the fine exposing position control.

The similar effect may be obtained by arranging the micromirror columns in a zigzag pattern by displacing each of the micromirror columns by a predetermined distance in the direction which is orthogonal to the subscanning direction, instead of inclining the DMD 50.

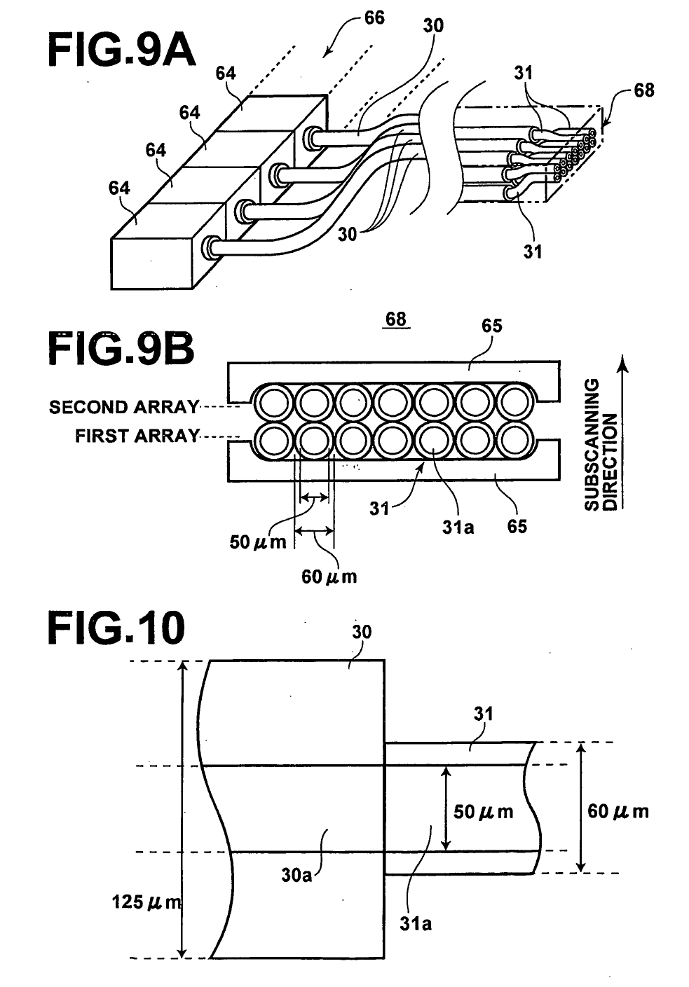

As shown in FIG. 9A, the fiber array light source 66 includes a plurality of laser modules 64 (e.g., 14), and one end of a length of multi-mode optical fiber 30 is connected to each of the laser modules 64. A length of optical fiber 31 having the same core diameter and smaller clad diameter than the multi-mode optical fiber 30 is spliced to the other end of each of the multi-mode optical fibers 30. As is illustrated in detail in FIG. 9B, each end face of seven optical fibers 31 on the side opposite to the multimode fiber 30 is aligned along the main scanning direction which is orthogonal to the subscanning direction, and two arrays of the end faces are disposed to form a laser output section 68.

The laser output section 68 formed of the end faces of the optical fibers 31 is fixedly sandwiched by two support plates 65 having a flat surface. Preferably, a transparent protection plate made of glass or the like is provided on each of the light output faces of the optical fibers 31 for protection. The light output face of each of the optical fibers 31 is likely to collect dust and prone to deterioration since it has a high optical density. Provision of the protection plate described above may prevent adhesion of dust and delay the deterioration.

In the present embodiment, the optical fiber 31 having a smaller clad diameter with the length of around 1 to 30 cm is spliced coaxially to the tip of the laser beam output side of the multimode fiber 30 having a greater clad diameter as shown in FIG. 10. The optical fibers 30, 31 are spliced together by fusion splicing the input face of the optical fiber 31 to the output face of the optical fiber 30 with the core axes being aligned. As described earlier, the optical fiber 31 has the same core diameter as the multimode optical fiber 30.

As for the multimode optical fiber 30 and optical fiber 31, a step index type optical fiber, graded index type optical fiber, or hybrid type optical fiber may be used. For example, a step index type optical fiber available from Mitsubishi Cable Industries, Ltd. may be used. In the present embodiment, the multimode optical fiber 30 and optical fiber 31 are step index type. The Multimode optical fiber 30 has a clad diameter of 125 μm, a core diameter of 50 μm, a NA of 0.2, and a transmittance for the coating of input face of 99.5%. The optical fiber 31 has a clad diameter of 60 μm, a core diameter of 50 μm, and a NA of 0.2.

However, the clad diameter of the optical fiber 31 is not limited to 60 μm. The clad diameter of many optical fibers used for a conventional optical fiber light source is 125 μm. Preferably the clad diameter of the multimode optical fiber is not greater than 80 μm, and more preferably not greater than 60 μm, since a smaller clad diameter results in a deeper focal depth. Preferably, the clad diameter of the optical fiber 31 is not less than 10 μm, since a single mode optical fiber requires a core diameter of at least 3 to 4 μm. Preferably, the optical fibers 30, 31 have the same core diameter from the stand point of coupling efficiency.

In the present embodiment, it is not necessarily required to use two different types of optical fibers 30, 31 having different clad diameters with each other by fusion splicing them together (so-called taper splicing). The fiber array light source may be formed by bundling a plurality of optical fibers having the same clad diameter (e.g., optical fibers 30 in FIG. 9A), each without a different type of optical fiber being spliced thereto.

The laser module 64 is constituted by a beam combining laser light source (fiber light source). The beam combining laser light source includes a plurality of transverse multimode or single mode GaN system semiconductor laser chips LD1, LD2, LD3, LD4, LD5, LD6 and LD7 fixedly disposed on a heat block 10; collimator lenses 11, 12, 13, 14, 15, 16, and 17, each provided for each of the GaN system semiconductor lasers LD1 to LD7; a condenser lens 20; and a multimode optical fiber 30. The number of the semiconductor lasers is not limited to seven, and different number of the semiconductor lasers may be employed. Further, instead of the seven separate collimator lenses 11 to 17, a collimator lens array in which these collimator lenses are integrated may be used.

Each of the GaN system semiconductor lasers LD1 to LD7 has substantially the same oscillation wavelength (e.g., 405 nm) and maximum output (e.g., around 100 mW for multimode laser, and 50 mW for single mode laser). The output of each of the GaN system semiconductor lasers LD1 to LD7 may differ with each other below the maximum output power. As for the GaN system semiconductor lasers LD1 to LD7, a laser that oscillates at a wavelength in the wavelength range from 350 to 450 nm other than at 405 nm may also be used.

The beam combining laser light source is contained in a box type package 40 having a top opening together with other optical elements. The package 40 includes a package lid formed to seal the opening of the package 40. A sealing gas is introduced into the package 40 after being deaerated, and the opening of the package 40 is sealed with the package lid 41 to air-tightly seal the beam combining laser light source within the closed space (sealing space) created thereby.

A base plate 42 is fixedly attached on the bottom surface of the package 40, and the heat block 10, a collimator lens holder 45 for holding the collimator lens 20, and a fiber holder 46 for holding the input end of the multimode fiber 30 are attached on the upper surface of the base plate 42. The output end of the multimode fiber 30 is drawn outside through an aperture provided on the wall of the package 40.

A collimator lens holder 44 is attached to a lateral surface of the heat block 10, and the collimator lenses 11 to 17 are held thereat. An aperture is provided on a lateral side wall through which wiring for supplying a drive current to the GaN system semiconductor lasers LD1 to LD7 is drawn outside.

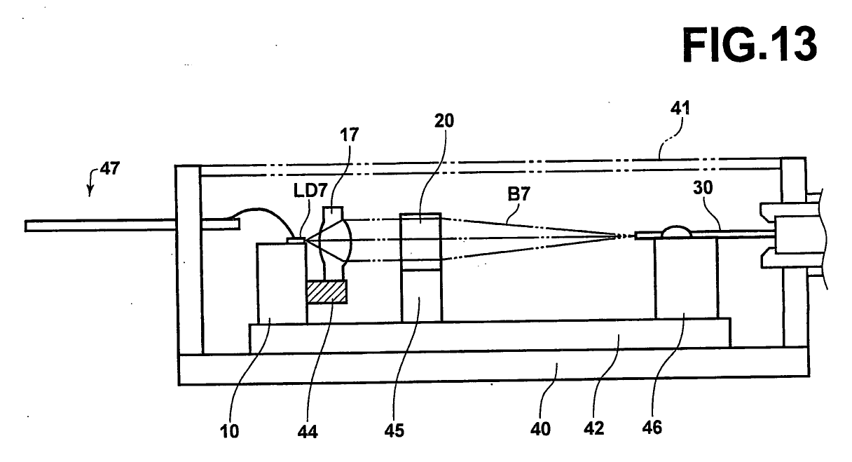

In FIG. 13, only the GaN system semiconductor laser LD1 out of the seven semiconductor lasers LD1 to LD7, and the collimator lens 17 out of the seven collimator lenses 11 to 17 are shown for clarity.

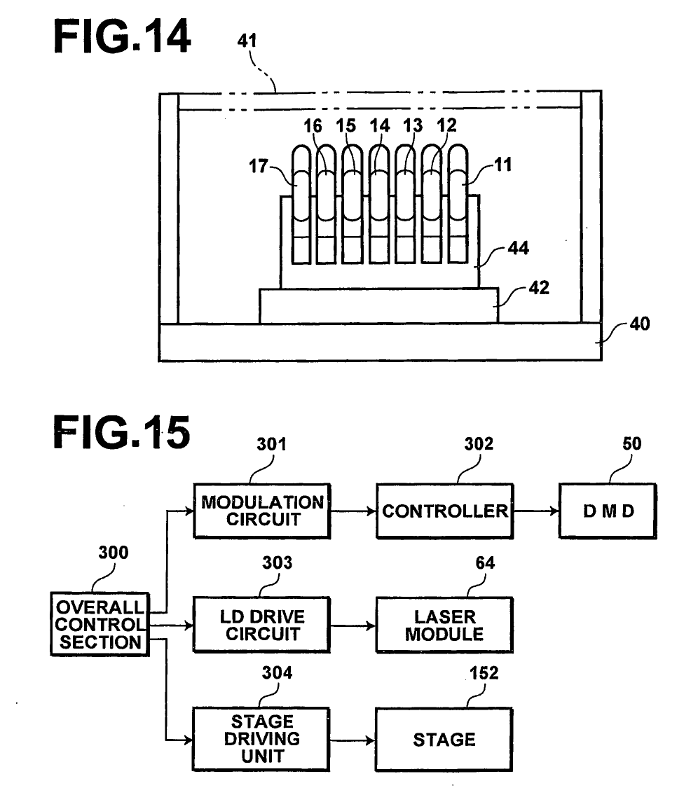

FIG. 14 is a front view of the mounting section of the collimator lenses 11 to 17, illustrating the front geometry thereof. Each of the collimator lenses 11 to 17 is formed such that a region including the optical axis of a circular lens having an aspheric surface is sliced out by parallel planes in an elongated form. The elongated collimator lens may be formed, for example, by molding resin or optical glass. The collimator lenses 11 to 17 are disposed closely with each other in the arranging direction of the luminous points of the GaN system semiconductor lasers LD1 to LD7 (left-to-right direction in FIG. 14) such that the length direction of the collimator lenses 11 to 17 is oriented in the direction which is orthogonal to the arranging direction of the luminous points of the GaN system semiconductor lasers LD1 to LD7.

In the mean time, as for the GaN system semiconductor lasers LD1 to LD7, lasers that include an active layer with a luminous width of 2 μm and emit respective laser beams B1 to B7 with the beam divergence angles of, for example, 10 degrees and 30 degrees respectively in the parallel and orthogonal directions to the active layer is used. The GaN system semiconductor lasers LD1 to LD7 are disposed such that the luminous points thereof are aligned linearly in the direction parallel to the active layer.

Accordingly, the laser beams B1 to B7 emitted from the respective luminous points enter the respective elongated collimator lenses 11 to 17 with the direction having a larger beam divergence angle corresponds to the length direction and the direction having a smaller beam divergence angle corresponds to the width direction (direction orthogonal to the length direction) of the collimator lenses. That is, the width of each of the collimator lenses 11 to 17 is 1.1 mm, the length thereof is 4.6 mm, and the beam diameters of the laser beams B1 to B7 entering the collimator lenses 11 to 17 in the horizontal and vertical directions are 0.9 mm and 2.6 mm respectively. Each of the collimator lenses 11 to 17 has a focal length f₁ of 3 mm and a NA of 0.6, which is arranged with a pitch of 1.25 mm.

The condenser lens 20 is formed such that a region including the optical axis of a circular lens having an aspheric surface is sliced out by parallel planes in an elongated form. It is disposed such that the long side thereof corresponds to the arranging direction of the collimator lenses 11 to 17, i.e., horizontal direction, and short side thereof corresponds to the direction orthogonal to the horizontal direction. The condenser lens 20 has a focal length f₂ of 23 mm and a NA of 0.2. The condenser lens 20 is also formed by molding resin or optical glass.

The electrical configuration of the image exposing apparatus according to the present invention will be described with reference to FIG. 15. As shown in FIG. 15, an overall control section 300 connects to a modulation circuit 301, which in turn connects to a controller 302 for controlling the DMD 50. The overall control section 300 also connects to an LD drive circuit 303 for driving laser modules 64. Further, it connects to a stage driving unit 304 for driving the stage 152.

### [Operation of the Image Exposing Apparatus]

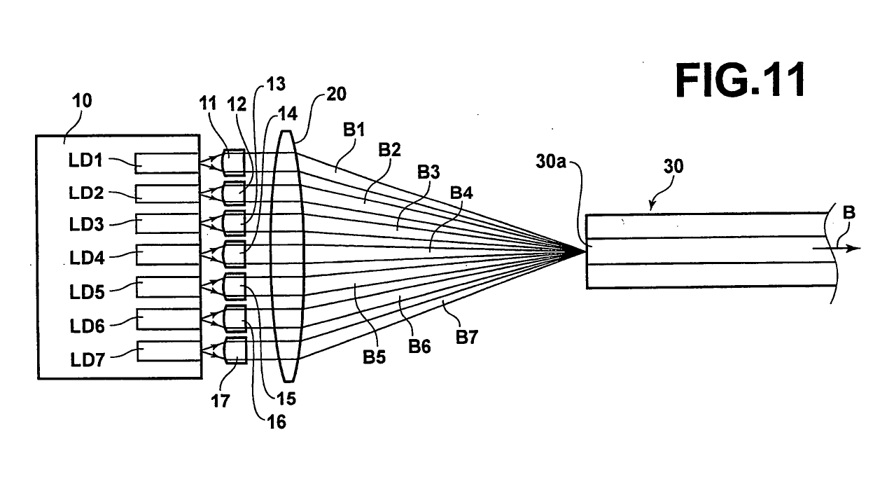

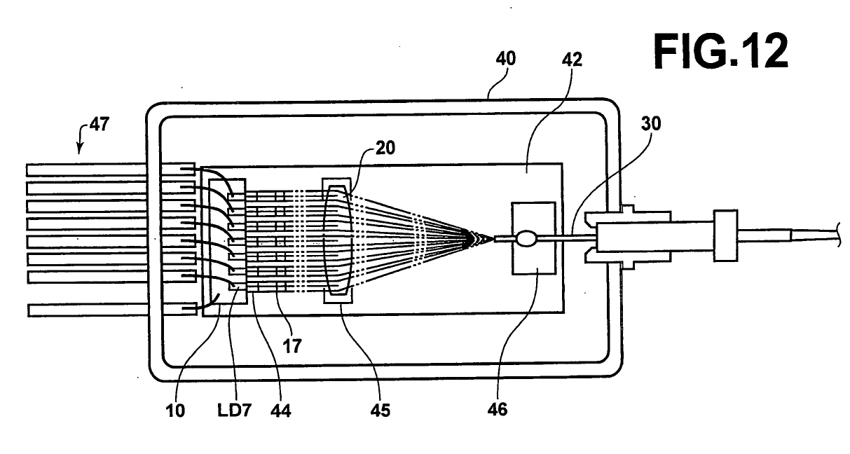

The operation of the aforementioned image exposing apparatus will be described hereinafter. In each of the exposing heads of the scanner 162, each of the laser beams B1, B2, B3, B4, B5, B6 and B7 emitted in diverging manner from each of the GaN system semiconductor lasers LD1 to LD7 (FIG. 11), which constitute a beam combining light source of the fiber array light source 66, is collimated by each of the corresponding collimator lenses 11 to 17. The collimated laser beams B1 to B7 are condensed by the condenser lens 20 and focused on the input end face of a core 30a of the multimode optical fiber 30.

In the present embodiment, the collimator lenses 11 to 17 and condenser lens 20 constitute a condensing optical system, and the condensing optical system and multimode optical fiber 30 constitute a beam combining optical system. That is, laser beams B1 to B7 condensed by the condenser lens 20 in the manner as described above enter the core 30a of the multimode optical fiber 30 to propagate therethrough, and exit from the optical fiber 31, which is spliced to the output end face of the multimode optical fiber 30, as a single combined laser beam B.

In each of the laser modules 64, when the coupling efficiency of the laser beams B1 to B7 to the multimode optical fiber 30 is 0.9, and output power of each of the GaN system semiconductor lasers LD1 to LD7 is 50 mW, a combined laser beam B having an output power of 315 mW (50 mW×0.9×7) from each of the optical fibers 31 arranged in arrays. Accordingly, from the total number of 14 optical fibers, a laser beam B having the output power of 4.4 W (0.315×14) may be obtained.

When performing an image exposure, image data according to the image to be exposed are inputted from the modulation circuit 301 shown in FIG. 15 to the controller 302 of the DMD 50 and temporarily stored in the frame memory thereof. The image data are data in which the gray level of each of the pixels forming the image is represented by a binary value (presence/absence of a dot).

The stage 152 with a photosensitive material 150 suctioned thereon is moved along the guides 158 at a constant speed from the upper stream to the down stream of the gate 160. When the stage 152 passes under the gate 160, and the front edge of the photosensitive material 150 is detected by the sensors 164 attached to the gate 160, the image data stored in the frame memory are sequentially read out for a plurality of lines at a time. Then, a control signal for each of the exposing heads 166 is generated on a head-by-head basis by the data processing section based on the readout image data, and each of the micromirrors of the DMD 50 in each of the exposing heads 166 is on-off controlled on a head-by-head basis by the mirror drive controlling section based on the generated control signal.

While the laser beam B is irradiated on the DMD 50 from the fiber array light source 66, a laser beam reflected by a micromirror driven to “on” of the DMD 50 is focused on the photosensitive material 150 through the lens system 51. In this way, the laser beam emitted from the fiber array light source 66 is on-off controlled on a pixel-by-pixel basis, and the photosensitive material 150 is exposed with the number of pixels (exposing areas 168) which is substantially equal to that of the pixels of the DMD used. The photosensitive material 150 is moved with the stage 152 at a constant speed so that the photosensitive material 150 is subscanned by the scanner 162 in the direction opposite to the stage moving direction, and a stripe-shaped exposed region 170 is formed by each of the exposing heads 166.

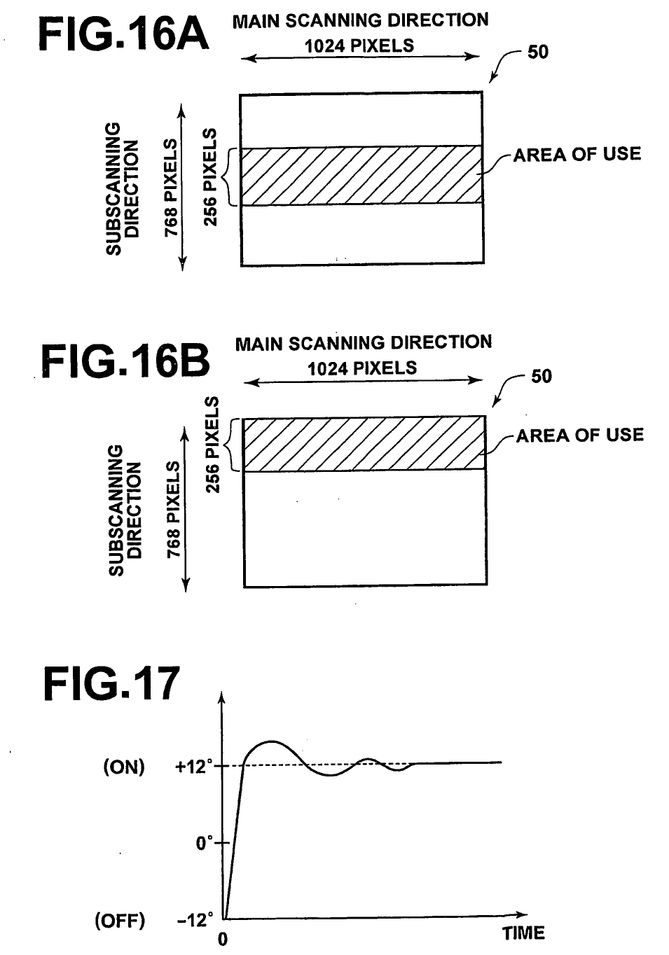

Although DMD 50 includes 768 arrays of micromirrors disposed in the subscanning direction, each having 1024 pieces of micromirrors disposed in the main scanning direction, only a part of the micromirror arrays (e.g., 1024 pieces×256 arrays) is drive controlled by the controller 302 in the present embodiment as shown in FIGS. 16A and 16B.

In this case, micromirror arrays disposed either in the central area (FIG. 16A), or top (or bottom) end area (FIG. 16B) of the DMD 50 may be used. In addition, if some of the micromirrors become defective, a micromirror array or arrays having no defective micromirror may be used instead of the micromirror array or arrays having the defective micromirrors. In this way, the micromirror arrays may be changed accordingly depending on the situation.

The DMD 50 has a certain limited data processing speed. The modulation speed per line is inversely proportional to the number of pixels used. Therefore, the modulation speed per line may be increased by using only a part of the entire micromirror arrays. In the mean time, for the exposing method in which the exposing heads are moved continuously relative to the exposing surface, not all of the pixels located in the subscanning direction need to be used.

When the subscanning of the photosensitive material 150 by the scanner 162 is completed, and the rear edge of the photosensitive material 150 is detected by the sensors 164, the stage 152 is returned to the original position on the uppermost stream of the gate 160 along the guides 158 by the stage driving unit 304. Thereafter, it is moved again along the guides 158 from the upper stream to down stream of the gate 160 at a constant speed.

Illumination optics, which are constituted by the fiber array light source 66, condenser lens 71, rod integrator 72, image forming lens 74, mirror 69, and TIR prism 70 shown in FIG. 5, for irradiating the laser beam B as illumination light on the DMD 50 will be described herein below. The rod integrator 72 is, for example, a transparent rod formed in a square pole. While the laser beam B propagates in the rod integrator 72 by total reflection, the intensity distribution within the cross-section of the laser beam B is homogenized. The input and output faces of the rod integrator 72 is provided with an antireflection coating to improve the transmittance. Provision of the laser beam B, which serves as the illumination light, having a highly homogenized intensity distribution within the cross-section in the manner as described above may result in the illumination light having a homogeneous light intensity, allowing a high resolution image to be exposed on the photosensitive material 150.

In the apparatus according to the present embodiment, the image of each of the micromirrors 62 of the DMD 50 is focused at the plane of each of the apertures 59a of the aperture array 59, which is then focused by the microlens array 55. This arrangement ensures that the image location focused by the microlens array 55 remains unchanged even when the incident angle of the laser beam B reflected by the micromirrors 62 to the apertures 59a is fluctuated due to the transient response characteristic of the micromirrors 62 as described earlier. Accordingly, this arrangement may prevent positional fluctuations of the beam on the photosensitive material 150 arising from the fluctuations in the incident angle described above, and the resolution of the exposed image is maintained satisfactorily.

Further, the image positioned at the plane of each of the apertures 59a of the aperture array 59 is focused by the microlens array 55 as described above, so that the beam diameter on the photosensitive material 150 remains unchanged even when the beam diameter of the beam B entering the aperture array 59 is fluctuated due to field curvature, astigmatic difference, and the like of the first image focusing optical system constituted by the lens systems 52, 54. This also allows a high resolution image to be exposed.

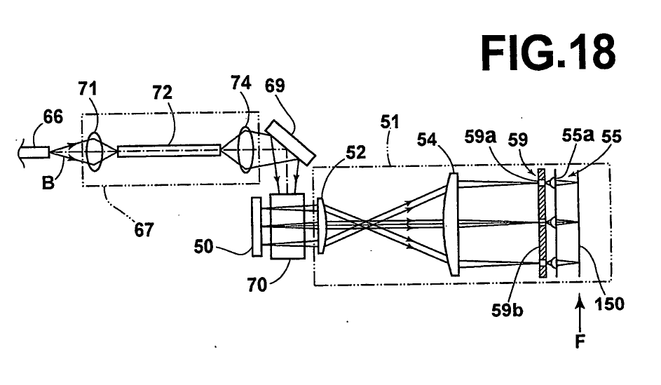

Hereinafter, a second embodiment of the present invention will be described. FIG. 18 is a schematic cross-sectional view of an exposing head of the image exposing apparatus according to the second embodiment. The exposing head of the second embodiment basically differs from the exposing head of the first embodiment in that it does not include the second image focusing optical system constituted by the lens systems 57, 58. That is, in the image exposing apparatus according to the second embodiment, the photosensitive material 150 is placed at the image location focused by each of the microlenses 55a of the microlens array 55, and the image focused by the microlens array 55 is exposed directly on the photosensitive material 150.

In the present embodiment also, as in the first embodiment, the image location focused by the microlens array 55 remains unchanged even when the incident angle of the laser beam B reflected by the micromirrors 62 to the apertures 59a is fluctuated. Accordingly, the second embodiment may provide basically the same advantageous effects as in the first embodiment. From the view points of ease of laying out the optical systems, adaptability to a warped photosensitive material, and the like, the first embodiment in which a greater distance may be provided between the optical system elements and photosensitive material might be preferable.

The image exposing apparatuses according to the first and second embodiments described above employ a DMD 50 as the spatial optical modulation device and degradation in the resolution of an exposed image due to the transient response characteristic of the micromirrors 62 of the DMD 50 is prevented. In an image exposing apparatus that employs a spatial optical modulation device other than DMD, the traveling direction of the light that focuses the images of the pixel sections of the spatial optical modulation device may fluctuate for one reason or another. The present invention may also be applied to such a case to prevent degradation in the resolution of the exposed image due to fluctuations in the incident angle of the light.

1.-4. (canceled)

5. An image exposing apparatus in which a photosensitive material is exposed by light propagated via a spatial optical modulation device to represent an image, the apparatus comprising:
the spatial optical modulation device including a plurality of pixel sections disposed in an array, each for modulating light irradiated thereon;
a light source for irradiating light on the spatial optical modulation device;
an image focusing optical system for condensing the light propagated via the spatial optical modulation device and focusing each of the pixel images of the pixel sections;
an aperture array made of an opaque material with a plurality of apertures disposed in an array, which is placed at the image location focused by the image focusing optical system such that each of the pixel images of the pixel sections is positioned at each of the aperture planes;
a microlens array including a plurality of microlenses disposed in an array, each for focusing each or the pixel images positioned at each of the aperture planes at a predetermined location; and
an optical system for focusing and projecting the image focused by the microlens array on the photosensitive material.

6. The image exposing apparatus according to claim 5, wherein the spatial optical modulation device comprises a DMD (digital micromirror device) in which micromirrors serving as the pixel sections are disposed two-dimensionally.

7. The image exposing apparatus according to claim 5, wherein the plurality of microlenses is disposed in a two-dimensional array.

8. The image exposing apparatus according to claim 5, wherein the plurality of microlenses is disposed in a one-dimensional array.

9. An image exposing apparatus in which a photosensitive material is exposed by light propagated via a spatial optical modulation device to represent an image, the apparatus comprising:
the spatial optical modulation device including a plurality of pixel sections disposed in an array, each for modulating light irradiated thereon;
a light source for irradiating light on the spatial optical modulation device;
an image focusing optical system for condensing the light propagated via the spatial optical modulation device and focusing each of the pixel images of the pixel sections;
an aperture array made of an opaque material with a plurality of apertures disposed in an array, which is placed at the image location focused by the image focusing optical system such that each of the pixel images of the pixel sections is positioned at each of the aperture planes; and
a microlens array including a plurality of microlenses disposed in an array, each for focusing each of the pixel images positioned at each of the aperture planes on the photosensitive material.

10. The image exposing apparatus according to claim 9, wherein the spatial optical modulation device comprises a DMD (digital micromirror device) in which micromirrors serving as the pixel sections are disposed two-dimensionally.

11. The image exposing apparatus according to claim 9, wherein the plurality of microlenses is disposed in a two-dimensional array.

12. The image exposing apparatus according to claim 9, wherein the plurality of microlenses is disposed in a one-dimensional array.

13. An image exposing method for exposing a predetermined pattern on a photo sensitive material using the image exposing apparatus according to claim 5.

14. An image exposing method for exposing a predetermined pattern on a photosensitive material using the image exposing apparatus according to claim 6.

15. An image exposing method for exposing a predetermined pattern on a photosensitive material using the image exposing apparatus according to claim 9.

16. An image exposing method for exposing a predetermined pattern on a photosensitive material using the image exposing apparatus according to claim 10.
